(19) United States
(12) Patent Application Publication
(10) Pub. No.: US 2026/0056911 A1
(43) Pub. Date: Feb. 26, 2026

(54) DYNAMICALLY ADJUSTING A DATA BUS CHARACTERISTIC BASED ON A WIRELESS CHANNEL

(71) Applicant: Microsoft Technology Licensing, LLC, Redmond, WA (US)

(72) Inventors: Tero Juhani PATANA, Kirkland, WA (US); Jason Allen HARRIGAN, Sultan, WA (US); Darrin Alan VEIT, Sammamish, WA (US)

(21) Appl. No.: 18/815,520

(22) Filed: Aug. 26, 2024

(51) Int. Cl. G06F 13/42; G06F 13/38

(52) U.S. Cl. CPC G06F 13/4282; G06F 13/382; G06F 2213/0042

(57) ABSTRACT

A computer-implemented method involves identifying a wireless band or channel linked to a wireless module's operation at a computer system. The method further includes detecting that the data bus is in a first data bus operation mode that causes radio frequency (RF) interference at the wireless band or channel and identifying a second data bus operation mode that mitigates RF interference at the wireless band or channel. Subsequently, the method configures the data bus to operate in the second data bus operation mode, thereby reducing RF interference and enhancing the computer system's overall performance and power usage.

### BACKGROUND

Wireless communication devices, such as laptops, tablets, smartphones, and smart televisions, often use data buses like UNIVERSAL SERIAL BUS (USB) or PERIPHERAL COMPONENT INTERCONNECT EXPRESS (PCIe) to interface with wireless communications hardware, such as WIRELESS FIDELITY (Wi-Fi) or BLUETOOTH modules. This wireless communications hardware operates in various frequency bands, such as 2.4 GHz, which can be subject to interference from other electronic devices and environmental factors.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including: identifying a wireless band or channel associated with the operation of a wireless module of a computer system; determining that a data bus is operating in a first data bus operation mode that generates radio frequency (RF) interference at the wireless band or channel; identifying a second data bus operation mode that reduces RF interference at the wireless band or channel; and configuring the data bus to operate in the second data bus operation mode.

In some aspects, the techniques described herein relate to methods, systems, and computer program products, including: detecting a wireless band or channel associated with the operation of a wireless module of a computer system; determining that a data bus is operating in a first data bus operation mode having a first data throughput rate; determining that the data bus could operate in a second data bus operation mode having a second data throughput rate that is greater than the first data throughput rate without generating RF interference at the wireless band or channel; and configuring the data bus to operate in the second data bus operation mode.

In some aspects, the techniques described herein relate to methods, systems, and computer program products, including: identifying a wireless band or channel associated with the operation of a wireless module of a computer system; determining that a data bus is operating in a first data bus operation mode that has a first data throughput rate; identifying a second data bus operation mode, the second data bus operation mode either: reducing RF interference at the wireless band or channel as compared to the first data bus operation mode; or operating with a second data throughput rate that is greater than the first data throughput rate without generating RF interference at the wireless band or channel; and configuring the data bus to operate in the second data bus operation mode.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that facilitates dynamically adjusting a data bus's speed based on a wireless device's channel;

FIG. 2 illustrates an example of a wireless adapter, such as a WIRELESS FIDELITY (Wi-Fi) dongle, that dynamically adjusts a data bus speed based on a wireless device's channel;

FIG. 3 illustrates an example of a 2.4 GHz Wi-Fi band;

FIG. 4 illustrates an example of the 5 GHz Wi-Fi band;

FIG. 5 illustrates an example of how a data bus clock spread spectrum and scrambling technique affects radio frequency (RF) interference by a Universal Serial Bus 3 data bus;

FIG. 6 illustrates a flow chart of an example of a method for adjusting a data bus operation mode to mitigate RF interference; and

FIG. 7 illustrates a flow chart of an example of a method for adjusting a data bus operation mode to promote Wi-Fi connection range and quality, such as latency, throughput, and loss.

### DETAILED DESCRIPTION

Different data bus types and protocols have distinct performance characteristics. Because they carry electrical signals that generate electromagnetic waves, some data buses can cause radio frequency (RF) interference with wireless communications hardware connected thereto, such as WIRELESS FIDELITY (Wi-Fi) or BLUETOOTH modules. These electromagnetic waves propagate through the air or metal components of the computer system and interfere with wireless devices that operate in the same frequency range. Depending on the length, shape, and layout of the data bus wires or cables, the data bus can act as an antenna that radiates or receives RF signals.

The frequencies of the electromagnetic waves a data bus generates are based on the data bus's clock and transmitted data patterns. In general, the higher the data transfer rate of the data bus, the higher the frequency of the signal and the more potential for interference. For instance, UNIVERSAL SERIAL BUS (USB) version 2 (USB 2) is slower than USB version 3 (USB 3) but generally causes less interference with Wi-Fi and BLUETOOTH signals than USB 3, particularly in the 2.4 and 6 GHz frequency bands (e.g., 2400-2500 MHz and 5925-7125 MHz, respectively). Conversely, USB 3 offers higher data transfer speeds but can generate significant RF noise that interferes with the 2.4 and 6 GHz Wi-Fi bands. On the other hand, the 5 GHz Wi-Fi band (e.g., 5150-5925 MHz) is less affected by USB 3 interference.

Embodiments described herein mitigate the RF interference caused by data buses, such as USB, which can interrupt wireless data communications via Wi-Fi, BLUETOOTH, etc. To mitigate RF interference, embodiments dynamically adjust data bus parameters, such as data speed, clock speed, and/or data scrambling, based on the wireless channel/band used by a wireless module attached to the data bus. For example, monitoring the wireless channel/band, the data speed of the data bus can be reduced (e.g., using the USB 2 protocol) when the device is using a wireless channel with high interference and increased (e.g., using the USB 3 protocol) when the device is using a wireless channel with low interference. These embodiments improve the performance and power consumption of wireless communications devices, for example, because fewer data need to be re-transmitted due to errors caused by RF interference, and/or lower power transmission levels can be used absent RF interference than if RF interference was present. Embodiments, therefore, enhance wireless communication quality and reliability by reducing the error rate, latency, and power consumption caused by RF interference. Some embodiments may also increase wireless communication range.

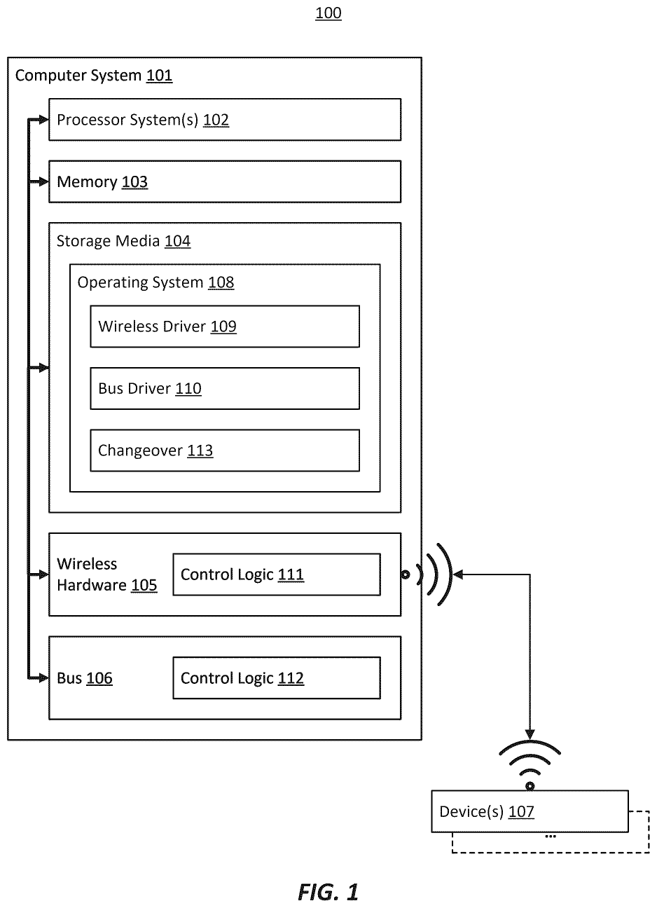

FIG. 1 illustrates an example of computer architecture 100 that facilitates dynamically adjusting a data bus's data speed based on a wireless device's channel/band, which can reduce RF interference and improve wireless communication quality and reliability. As shown, computer architecture 100 includes a computer system 101 comprising a processor system 102 (e.g., a single processor or a plurality of processors), a memory 103 (e.g., system or main memory), a storage medium 104 (e.g., a single computer-readable storage medium, or a plurality of computer-readable storage media), and a wireless hardware 105 (e.g., Wi-Fi hardware, BLUETOOTH hardware). These components are interconnected by one or more data buses, including data bus 106. While computer architecture 100 can include various data bus types, in some examples, data bus 106 is a USB data bus that connects wireless hardware 105 to other components of computer system 101 (either directly or via other data bus types, such as PERIPHERAL COMPONENT INTERCONNECT EXPRESS (PCIe), THUNDERBOLT, etc.).

FIG. 1 illustrates the storage medium 104 as storing computer-executable instructions implementing at least an operating system 108 that includes, among other things, drivers such as a wireless driver 109 that interfaces with control logic 111 (e.g., hardware, firmware) of wireless hardware 105 and a data bus driver 110 that interfaces with control logic 112 (e.g., hardware, firmware) of data bus 106.

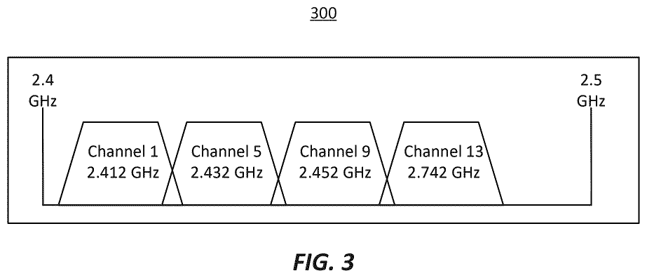

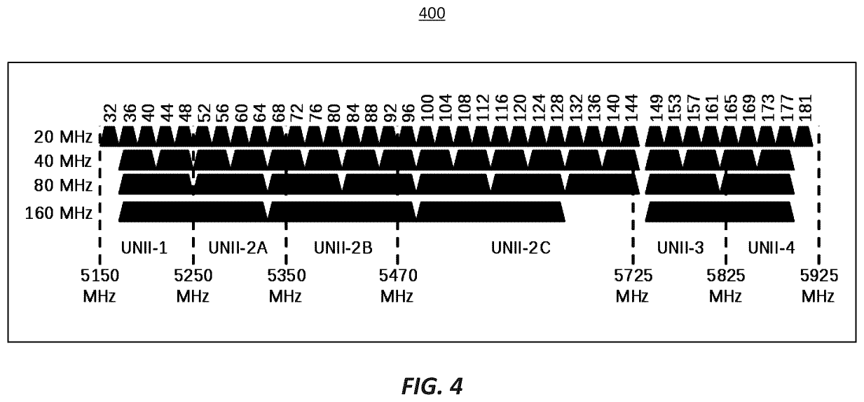

As shown, wireless hardware 105 wirelessly communicates with one or more other electronic devices, shown as device(s) 107. Examples of device(s) 107 include computer systems, Wi-Fi routers, accessories (e.g., keyboard, mouse, game controller), etc. This communication may include, for example, BLUETOOTH and/or Wi-Fi communications. When communicating via Wi-Fi, wireless hardware 105 may interface with device(s) 107 using various frequency bands depending on Wi-Fi protocol, such as the 2.4, 5, or 6 GHz frequency bands. FIG. 3 illustrates an example 300 of the 802.11g/n 2.4 GHz Wi-Fi band, showing 4 non-overlapping channels, each 20 MHz wide. FIG. 4 illustrates an example 400 of the 5 GHz Wi-Fi band, showing that there are many different channels with various bandwidth options, ranging from 20 to 160 MHz.

One of the challenges faced by computer architecture 100 is the possibility of data bus 106 causing RF interference with the communications between wireless hardware 105 and device(s) 107. The data bus 106, which connects the wireless hardware 105 to other components of the computer system, can generate electromagnetic waves that propagate through the air or metal components and interfere with the wireless signals transmitted or received by the wireless hardware 105. This interference can degrade the quality and reliability of wireless communication, causing errors, latency, increased power consumption, and decreased wireless range.

The degree of interference depends on the frequency content of the data bus 106 (e.g., which can be related to the bus's data speed, the bus's clock harmonics, and/or data scrambling), the frequency band used by the wireless hardware 105, and the layout of the wires or cables of the data bus 106 within computer system 101. For example, a USB 3 data bus can cause significant RF noise for the 2.4 and 6 GHz Wi-Fi bands but generally does not interfere with the 5 GHz Wi-Fi band. Conversely, a USB 2 data bus generally does not cause Wi-Fi interference but has lower data transfer speeds than a USB 3 data bus. Therefore, there is a trade-off between the performance of the data bus 106 and the performance of wireless communications by the wireless hardware 105, depending on the wireless band or channel used by the wireless hardware.

In the embodiments herein, computer architecture 100 also includes a changeover component 113 that operates to actively manage this trade-off by altering the behavior of data bus 106 to proactively mitigate RF interference with wireless hardware 105 (e.g., by decreasing the performance of the data bus 106 to USB 2 standards when the wireless hardware 105 is using 2.4 or 6 GHz frequency bands), and to increase the performance of data bus 106 when possible (e.g., by increasing the performance of the data bus 106 to USB 3 standards when the wireless hardware 105 is using 5 GHz frequency bands). While changeover component 113 is illustrated as being a distinct component of operating system 108, alternative embodiments may integrate changeover component 113 into one or more drivers (e.g., wireless driver 109, data bus driver 110) and/or into hardware or firmware control logic (e.g., control logic 111, control logic 112).

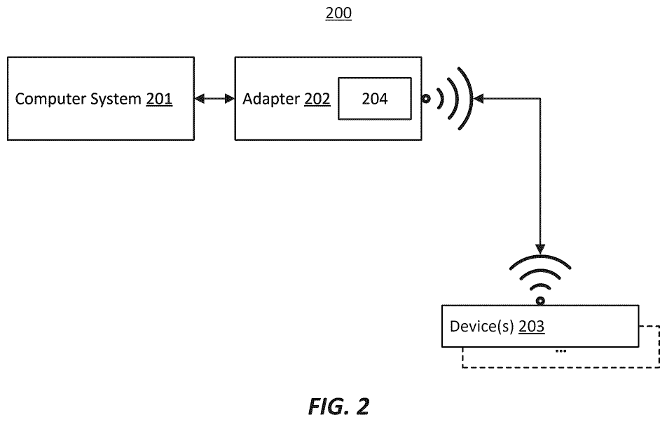

Notably, some embodiments may implement the functionality of changeover component 113 separately from computer system 101. For example, FIG. 2 illustrates an example 200 in which a wireless adapter, such as a Wi-Fi dongle, dynamically adjusts a data bus speed based on a wireless device's channel. Example 200 shows that a wireless adapter 202 is connected to a computer system 201 and that the wireless adapter 202 communicates wirelessly with device(s) 203. In example 200, the wireless adapter 202 is connected to computer system 201 via a configurable data bus, such as USB, and can alter how it is enumerated at that data bus. For example, the wireless adapter 202 can present itself to computer system 201 as either a USB 2 or USB 3 device. In example 200, wireless adapter 202 includes a changeover component 204 that dynamically adjusts how wireless adapter 202 presents itself to computer system 201, depending on the wireless band or channel being used to communicate with device(s) 203. Thus, the wireless adapter 202 can dynamically adjust a data bus speed based on a wireless channel independent of computer system 201.

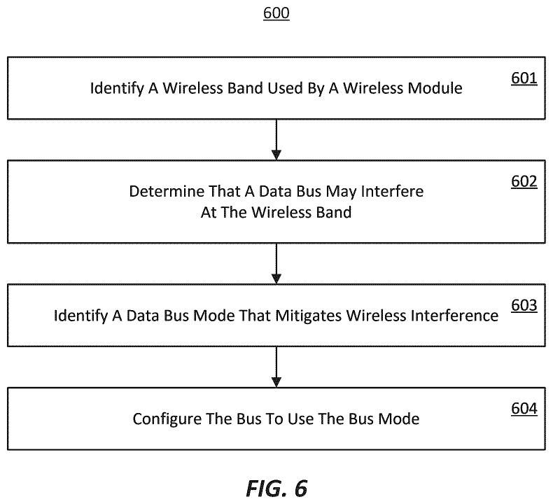

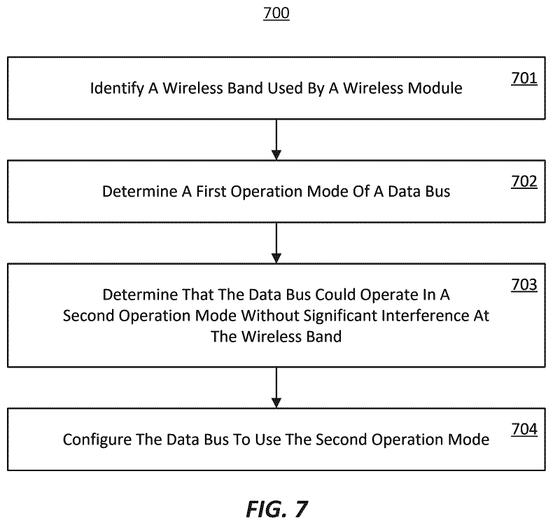

The operation of the changeover components 113 and 204 is now described in connection with FIGS. 6 and 7, which illustrate embodiments for dynamically adjusting a data bus's speed based on a wireless device's channel. The following discussion now refers to methods and acts. Although the method acts are discussed in specific orders or illustrated in a flow chart as occurring in a particular order, no order is required unless expressly stated or required because an act depends on another act being completed before the act being performed.

FIG. 6 illustrates a flow chart of an example method 600 for adjusting a data bus operation mode to mitigate RF interference. In embodiments, instructions for implementing method 600 are encoded as computer-executable instructions (e.g., changeover component 113, changeover component 204) stored on a computer storage medium (e.g., storage medium 104) that are executable by a processor (e.g., processor system 102) to cause a computer system (e.g., computer system 101) to perform method 600.

Referring to FIG. 6, in embodiments, method 600 comprises act 601 of identifying a wireless band or channel used by a wireless module. In some embodiments, act 601 comprises identifying a wireless band or channel associated with the operation of a wireless module of the computer system. For example, in reference to FIG. 1, changeover component 113 determines a wireless band or channel being used, or to be used, by wireless hardware 105 to communicate with device(s) 107. In another example, in reference to FIG. 2, changeover component 204 determines a wireless band or channel being used, or to be used, by wireless adapter 202 to communicate with device(s) 203. In some embodiments, identifying the wireless band or channel associated with the operation of the wireless module includes identifying a particular Wi-Fi channel, or even a particular range of RF frequencies, used by the wireless module. In one particular example of act 601, the wireless band or channel identified in act 601 is within a 2.4 or 6 GHz Wi-Fi frequency band, which may be subject to RF interference by a USB 3 data bus. In this particular example, the changeover component 113, 204, may identify a particular 2.4 or 6 GHz Wi-Fi channel (see FIG. 3).

Method 600 also comprises act 602 of determining that a data bus may interfere at the wireless band or channel. In some embodiments, act 602 comprises determining that the data bus is operating in a first data bus operation mode that generates RF interference at the wireless band or channel. For example, in reference to FIG. 1, changeover component 113 determines that, as it is presently operating, data bus 106 may generate RF interference at the wireless band or channel identified in act 601. In another example, in reference to FIG. 2, changeover component 204 determines that, as it is presently operating, wireless adapter 202 is using a data bus type that may generate RF interference at the wireless band or channel identified in act 601. In one particular example of act 602, the data bus 106/wireless adapter 202 is operating in a USB 3 mode, which may interfere with a 2.4 or 6 GHz Wi-Fi frequency band identified in act 601.

Method 600 also comprises act 603 of identifying a data bus mode that mitigates wireless interference. In some embodiments, act 603 comprises identifying a second data bus operation mode that reduces RF interference at the wireless band or channel. For example, in reference to FIG. 1, changeover component 113 determines that RF interference at the 2.4 or 6 GHz Wi-Fi band could be mitigated by operating data bus 106 in a USB 2 mode. In another example, in reference to FIG. 2, changeover component 204 determines that RF interference at the 2.4 or 6 GHz Wi-Fi band could be mitigated by presenting wireless adapter 202 to computer system 201 as a USB 2 device. This means that the performance characteristics of data bus 106/wireless adapter 202 can be altered to avoid adversely affecting wireless communications performance, power usage, range, etc.

Method 600 also comprises act 604 of configuring the data bus to use the data bus mode. In some embodiments, act 604 comprises configuring the data bus to operate in the second data bus operation m ode. For example, in reference to FIG. 1, changeover component 113 instructs data bus 106 to change operation from USB 3 mode to USB 2 mode (e.g., via communications with data bus driver 110 or control logic 112). In another example, in reference to FIG. 2, changeover component 204 causes wireless adapter 202 to change its operating state from USB 3 mode to USB 2 mode. In both cases, this has the technical effect of reducing RF interference at the wireless band or channel identified in act 601, which improves wireless performance (e.g., data rate, latency, range) and reduces power consumption.

In the example of FIG. 1, configuring the data bus to operate in the second data bus operation mode may include re-initializing the data bus 106, re-enumerating devices on the data bus 106, etc. In embodiments, this may mean that wireless hardware 105 becomes temporarily unavailable, with wireless driver 109 re-initializing the wireless hardware 105 when it reappears on the data bus 106. In some embodiments, wireless driver 109 and/or control logic 111 may be enlightened to communicate with changeover component 113 to improve the speed of the re-initialization. For example, wireless driver 109 and/or control logic 111 may be pre-configured with current Wi-Fi connection parameters to use upon re-initialization.

In the example of FIG. 2, configuring the data bus to operate in the second data bus operation mode may mean that wireless adapter 202 appears to disconnect from computer system 201 and then re-connect in a different mode. Similarly to the foregoing example of FIG. 1, computer system 201 may communicate with changeover component 204 to improve the speed of the re-initialization.

FIG. 7 illustrates a flow chart of an example method 700 for adjusting a data bus operation mode to promote Wi-Fi connection range and quality, such as latency, throughput, and loss. In embodiments, instructions for implementing method 700 are encoded as computer-executable instructions (e.g., changeover component 113, changeover component 204) stored on a computer storage medium (e.g., storage medium 104) that are executable by a processor (e.g., processor system 102) to cause a computer system (e.g., computer system 101) to perform method 700.

Referring to FIG. 7, in embodiments, method 700 comprises act 701 of identifying a wireless band or channel used by a wireless module. In some embodiments, act 701 comprises detecting a wireless band or channel associated with the operation of a wireless module of the computer system. For example, in reference to FIG. 1, changeover component 113 determines a wireless band or channel being used, or to be used, by wireless hardware 105 to communicate with device(s) 107. In another example, in reference to FIG. 2, changeover component 204 determines a wireless band or channel being used, or to be used, by wireless adapter 202 to communicate with device(s) 203. In some embodiments, identifying the wireless band or channel associated with the operation of the wireless module includes identifying a particular Wi-Fi channel, or even a particular range of RF frequencies, used by the wireless module. In one particular example of act 701, the wireless band or channel identified in act 701 is within a 5 GHz Wi-Fi frequency band, which may be resilient to RF interference by a USB 3 data bus. In this particular example, the changeover component 113, 204, may identify a particular 5 GHz Wi-Fi channel (see FIG. 4).

Method 700 also comprises act 702 of determining a first operation mode of a data bus. In some embodiments, act 702 comprises determining that the data bus is operating in a first data bus operation mode having a first data throughput rate. For example, in reference to FIG. 1, changeover component 113 determines that data bus 106 is operating in a USB 2 mode. In another example, in reference to FIG. 2, changeover component 204 determines that wireless adapter 202 is using USB2 to communicate with computer system 201.

Method 700 also comprises act 703 of determining that the data bus could operate in a second operation mode without significant interference at the wireless band or channel. In some embodiments, act 703 comprises determining that the data bus could operate in a second data bus operation mode with a second data throughput rate greater than the first data throughput rate without generating RF interference at the wireless band or channel. For example, in reference to FIG. 1, changeover component 113 determines that data bus 106 could be operated in a USB 3 mode without causing significant RF interference at the 5 GHz Wi-Fi bands. In another example, in reference to FIG. 2, changeover component 204 determines that wireless adapter 202 would operate in a USB 2.0 mode without causing significant RF interference at the 5 GHz Wi-Fi bands. This means that the performance of data bus 106/wireless adapter 202 can be improved without adversely affecting wireless communications performance, power usage, etc.

Method 700 also comprises act 704 of configuring the data bus to use the second operation mode. In some embodiments, act 704 comprises configuring the data bus to operate in the second data bus operation mode. For example, in reference to FIG. 1, changeover component 113 instructs data bus 106 to change operation from USB 2 mode to USB 3 mode (e.g., via communications with data bus driver 110 or control logic 112). In another example, in reference to FIG. 2, changeover component 204 causes wireless adapter 202 to change its operating state from USB 2 mode to USB 3 mode. In both cases, this has the technical effect of improving bus performance (e.g., data throughput) while ensuring there will be no significant RF interference at the wireless band or channel identified in act 701.

In the example of FIG. 1, configuring the data bus to operate in the second data bus operation mode may include re-initializing the data bus 106, re-enumerating devices on the data bus 106, etc. In embodiments, this may mean that wireless hardware 105 becomes temporarily unavailable, with wireless driver 109 re-initializing the wireless hardware 105 when it reappears on the data bus 106. In some embodiments, wireless driver 109 and/or control logic 111 may be enlightened to communicate with changeover component 113 to improve the speed of the re-initialization. For example, wireless driver 109 and/or control logic 111 may be pre-configured with current Wi-Fi connection parameters to use upon re-initialization.

In the example of FIG. 2, configuring the data bus to operate in the second data bus operation mode may mean that wireless adapter 202 appears to disconnect from computer system 201 and then re-connect in a different mode. Similarly to the foregoing example of FIG. 1, computer system 201 may communicate with changeover component 204 to improve the speed of the re-initialization.

In embodiments, a device operates to perform both of method 600 and method 700 or a hybrid method. This means that the device can dynamically manage the trade-off between the performance of a data bus and wireless communications, depending on the wireless or channel band used by the wireless hardware. For example, in embodiments, based on identifying a wireless band or channel used by a wireless module, the device identifies a data bus operation mode that either reduces RF interference at the wireless band or channel mode (e.g., as per method 600) or operates with an increased throughput rate without generating RF interference at the wireless band or channel (e.g., as per method 700), and configures the data bus to operate in this data bus operation mode.

The examples in the foregoing description have focused primarily on identifying a general Wi-Fi band (e.g., 2.4, 5, or 6 GHz) and switching between different data bus protocols (e.g., USB 2 or USB 3). Some embodiments operate at a greater level of granularity. For example, these embodiments may identify a particular channel within a Wi-Fi band and alter one or more data bus protocol parameters to reduce RF interference at that channel (e.g., by creating an RF null) rather than switching data bus protocols entirely. In some examples, embodiments may alter the data bus's clock speed, the data bus's clock spread spectrum (e.g., the variation/jitter in the data bus's clock rate), and/or a type of data scrambling used by the data bus. Each parameter can be used to alter an RF noise profile generated by the data bus, including a null location where RF interference is reduced.

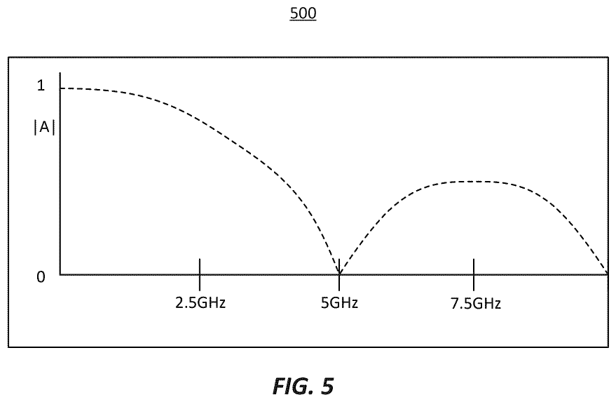

For example, FIG. 5 illustrates an example 500 of an RF noise profile generated by a USB 3 data bus. In particular, example 500 illustrates a USB 3 data spectrum, modeled as a sinc function. In example 500, this sinc function ranges from direct current to 5 GHz, but due to the USB 3 clock rate, clock spread spectrum, and data scrambling, there is a ‘null’ at about 5 GHz. Thus, the USB 3 data bus's clock spread spectrum and data scrambling is configured to mitigate interference at the 5 GHz band, corresponding to most modern Wi-Fi protocols.

Some embodiments alter a data bus clock characteristic, such as the data bus's clock speed, clock spread spectrum, data scrambling, etc., to steer the null of the data bus's RF spectrum profile towards a particular Wi-Fi channel. Thus, for example, in the context of method 600, the second data bus operation mode alters the clock speed of the data bus 106, the clock spread spectrum of the data bus 106, and/or the data scrambling of the data bus 106 such that the RF spectrum profile of the data bus 106 reduces RF interference at the wireless band, and, embodiments, at a particular wireless channel.

Notably, just as the operation of a data bus generates RF interference, so does the operation of other devices connected to the data bus. Some embodiments account for the RF interference contribution of these other devices. For example, in some embodiments, changeover component 113 determines that a device connected to data bus 106 contributes to generating RF interference at the wireless band or channel when it uses this determination when identifying the second data bus operation mode. For example, depending on the requirements of this other device, changeover component 113 may choose not actually to change data bus protocols, may proactively change data bus protocols based on the device being connected, or may take this other device into account when choosing a data bus clock speed, clock spread spectrum, data scrambling technique, etc.

While the foregoing embodiments have been described primarily in the context of USB and Wi-Fi, the principles described herein can apply to configurations that use various types of data buses (e.g., USB, PCIe, THUNDERBOLT) and wireless communication types (e.g., BLUETOOTH, Wi-Fi). Thus, unless otherwise specified, these embodiments should not be interpreted as being limited to USB data busses and Wi-Fi wireless hardware.

Alternatively or in addition to the other examples described herein, examples include any combination of the following:
Clause 1. A method implemented in a computer system, comprising: identifying a wireless band or channel associated with operation of a wireless module of the computer system; determining that a data bus is operating in a first data bus operation mode that generates radio frequency (RF) interference at the wireless band or channel; identifying a second data bus operation mode that reduces RF interference at the wireless band or channel; and configuring the data bus to operate in the second data bus operation mode.
Clause 2. The method of clause 1, wherein the wireless band or channel is within a 2400-2500 MHz frequency range or a 5925-7125 MHz frequency range.
Clause 3. The method of any one of clause 1 or claim 2, wherein identifying the wireless band or channel associated with operation of the wireless module includes identifying a wireless fidelity (Wi-Fi) channel used by the wireless module.
Clause 4. The method of any one of clause 1 to claim 3, wherein the data bus is a universal serial bus (USB), the first data bus operation mode is USB 3, and the second data bus operation mode is USB 2.
Clause 5. The method of any one of clause 1 to claim 4, wherein the second data bus operation mode alters a clock spectrum of the data bus or a data scrambling technique of the data bus to reduce RF interference at the wireless band or channel.
Clause 6. The method of any one of clause 1 to claim 5, wherein the second data bus operation mode alters an RF spectrum profile of the data bus to reduce RF interference at the wireless band or channel.
Clause 7. The method of any one of clause 1 to claim 6, wherein the wireless module is connected to the data bus.
Clause 8. The method of any one of clause 1 to claim 7, wherein the wireless module is within a dongle connected to the computer system.
Clause 9. The method of any one of clause 1 to claim 8, wherein configuring the data bus to operate in the second data bus operation mode includes enumerating devices on the data bus, including enumerating the wireless module on the data bus.
Clause 10. The method of any one of clause 1 to claim 9, wherein configuring the data bus to operate in the second data bus operation mode includes re-initializing the data bus.
Clause 11. The method of any one of clause 1 to claim 10, wherein the method further comprises: determining that a device connected to the data bus contributes to generating RF interference at the wireless band or channel; and identifying the second data bus operation mode includes determining that the second data bus operation mode mitigates RF interference by the device.
Clause 12. A method implemented in a computer system, comprising: detecting a wireless band or channel associated with operation of a wireless module of the computer system; determining that a data bus is operating in a first data bus operation mode having a first data throughput rate; determining that the data bus could operate in a second data bus operation mode having a second data throughput rate that is greater than the first data throughput rate without generating radio frequency (RF) interference at the wireless band or channel; and configuring the data bus to operate in the second data bus operation mode.
Clause 13. The method of clause 12, wherein the wireless band or channel is within a 5150-5925 MHz frequency range.
Clause 14. The method of any one of clause 12 or claim 13, wherein identifying the wireless band or channel associated with operation of the wireless module includes identifying a wireless fidelity (Wi-Fi) channel used by the wireless module.
Clause 15. The method of any one of clause 12 to claim 14, wherein the data bus is a universal serial bus (USB), the first data bus operation mode is USB 2, and the second data bus operation mode is USB 3.
Clause 16. The method of any one of clause 12 to claim 15, wherein the wireless module is within a dongle connected to the computer system.
Clause 17. The method of any one of clause 12 to claim 16, wherein configuring the data bus to operate in the second data bus operation mode includes enumerating devices on the data bus, including enumerating the wireless module on the data bus.
Clause 18. A computer system, comprising: a processor system; a data bus; and a computer storage medium that stores computer-executable instructions that are executable by the processor system to at least: identify a wireless band or channel associated with operation of a wireless module of the computer system; determine that the data bus is operating in a first data bus operation mode that has a first data throughput rate; identify a second data bus operation mode, the second data bus operation mode either: reducing radio frequency (RF) interference at the wireless band or channel as compared to the first data bus operation mode; or operating with a second data throughput rate that is greater than the first data throughput rate without generating RF interference at the wireless band or channel; and configure the data bus to operate in the second data bus operation mode.
Clause 19. The computer system of clause 18, wherein the wireless band or channel is within a wireless fidelity (Wi-Fi) frequency range.
Clause 20. The computer system of any one of clause 18 to claim 19, wherein the data bus is a universal serial bus (USB), the first data bus operation mode is USB 2, and the second data bus operation mode is USB 3.

Embodiments of the disclosure comprise or utilize a special-purpose or general-purpose computer system (e.g., computer system 101) that includes computer hardware, such as, for example, a processor system (e.g., processor system 102) and system memory (e.g., memory 103), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage medium 104). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., wireless hardware 105) and eventually transferred to computer system RAM and/or less volatile computer storage media at a computer system. Thus, computer storage media can be included in computer system components that also utilize transmission media.

Computer-executable instructions comprise, for example, instructions and data which, when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an operating system and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a computer system, comprising:
identifying a wireless band or channel associated with operation of a wireless module of the computer system;
determining that a data bus is operating in a first data bus operation mode that generates radio frequency (RF) interference at the wireless band or channel;
identifying a second data bus operation mode that reduces RF interference at the wireless band or channel; and
configuring the data bus to operate in the second data bus operation mode.

2. The method of claim 1, wherein the wireless band or channel is within a 2400-2500 MHz frequency range or a 5925-7125 MHz frequency range.

3. The method of claim 1, wherein identifying the wireless band or channel associated with operation of the wireless module includes identifying a wireless fidelity (Wi-Fi) channel used by the wireless module.

4. The method of claim 1, wherein the data bus is a universal serial bus (USB), the first data bus operation mode is USB 3, and the second data bus operation mode is USB 2.

5. The method of claim 1, wherein the second data bus operation mode alters a clock spectrum of the data bus or a data scrambling technique of the data bus to reduce RF interference at the wireless band or channel.

6. The method of claim 1, wherein the second data bus operation mode alters an RF spectrum profile of the data bus to reduce RF interference at the wireless band or channel.

7. The method of claim 1, wherein the wireless module is connected to the data bus.

8. The method of claim 1, wherein the wireless module is within a dongle connected to the computer system.

9. The method of claim 1, wherein configuring the data bus to operate in the second data bus operation mode includes enumerating devices on the data bus, including enumerating the wireless module on the data bus.

10. The method of claim 1, wherein configuring the data bus to operate in the second data bus operation mode includes re-initializing the data bus.

11. The method of claim 1, wherein the method further comprises:
determining that a device connected to the data bus contributes to generating RF interference at the wireless band or channel; and
identifying the second data bus operation mode includes determining that the second data bus operation mode mitigates RF interference by the device.

12. A method implemented in a computer system, comprising:
detecting a wireless band or channel associated with operation of a wireless module of the computer system;
determining that a data bus is operating in a first data bus operation mode having a first data throughput rate;
determining that the data bus could operate in a second data bus operation mode having a second data throughput rate that is greater than the first data throughput rate without generating radio frequency (RF) interference at the wireless band or channel; and
configuring the data bus to operate in the second data bus operation mode.

13. The method of claim 12, wherein the wireless band or channel is within a 5150-5925 MHz frequency range.

14. The method of claim 12, wherein identifying the wireless band or channel associated with operation of the wireless module includes identifying a wireless fidelity (Wi-Fi) channel used by the wireless module.

15. The method of claim 12, wherein the data bus is a universal serial bus (USB), the first data bus operation mode is USB 2, and the second data bus operation mode is USB 3.

16. The method of claim 12, wherein the wireless module is within a dongle connected to the computer system.

17. The method of claim 12, wherein configuring the data bus to operate in the second data bus operation mode includes enumerating devices on the data bus, including enumerating the wireless module on the data bus.

18. A computer system, comprising:
a processor system;
a data bus; and
a computer storage medium that stores computer-executable instructions that are executable by the processor system to at least:
identify a wireless band or channel associated with operation of a wireless module of the computer system;
determine that the data bus is operating in a first data bus operation mode that has a first data throughput rate;
identify a second data bus operation mode, the second data bus operation mode either:
reducing radio frequency (RF) interference at the wireless band or channel as compared to the first data bus operation mode; or
operating with a second data throughput rate that is greater than the first data throughput rate without generating RF interference at the wireless band or channel; and
configure the data bus to operate in the second data bus operation mode.

19. The computer system of claim 18, wherein the wireless band or channel is within a wireless fidelity (Wi-Fi) frequency range.

20. The computer system of claim 18, wherein the data bus is a universal serial bus (USB), the first data bus operation mode is USB 2, and the second data bus operation mode is USB 3.
